(19) United States
(12) Patent Application Publication
(10) Pub. No.: US 2026/0112338 A1
(43) Pub. Date: Apr. 23, 2026

(54) HI-HAT ASSEMBLY WITH DUAL SPRING SYSTEM, QUICK RELEASE RODS, AND/OR ADJUSTABLE AND FOLDABLE PEDAL

(71) Applicant: DRUM WORKSHOP, INC., Oxnard, CA (US)

(72) Inventors: Ruben STEINHAUSER, Altusried (DE); Richard A. SIKRA, Thousand Oaks, CA (US)

(21) Appl. No.: 18/918,484

(22) Filed: Oct. 17, 2024

(51) Int. Cl. G10D 13/11; G10D 13/065

(52) U.S. Cl. CPC G10D 13/11; G10D 13/065

(57) ABSTRACT

Hi-hat assemblies are disclosed which can include one or more adjustment features, quick release rods, folding pedal assemblies, and spring systems. Adjustment features which can be included in embodiments of the present disclosure can include components for adjusting pedal height and/or tension or resistance (such as due to a connection to one or more springs). Some embodiments disclosed enable independent adjustment of pedal height and resistance. The inclusion of a negative spring in spring systems disclosed herein can eliminate or reduce unpleasant sounds caused by pedals returning to a resting position upon the removal of a user's foot from the pedal. Pedal assemblies according to some embodiments of the present disclosure can include foldable base plates for easy storage and travel.

### BACKGROUND OF THE INVENTION

### Field of the Invention

This invention relates generally to drum/cymbal pedal assemblies that can connect to drums and/or cymbals, such as hi-hat systems. Some embodiments of the invention relate to hi-hat assemblies with features that can adjust the tension, resistance, and/or delay time that a user experiences upon actuating the pedal, as well as the height of the pedal; and to quick release mechanisms usable with such pedals and assemblies.

### Description of the Related Art

A hi-hat is a common component of a drum set that includes two cymbals facing one another and mounted on a vertical tube or pole. A hi-hat can be operated in many different ways, including by a foot pedal which can cause the cymbals to strike one another, or by actuation using a drumstick, among other operation methods. The top and/or bottom cymbal can be adjustable so as to be mounted at different heights; in many prior art systems, the height of the top cymbal is adjustable. One example of a prior art hi-hat, features of which can be combined with those of the present disclosure, is U.S. Pat. No. 9,640,154 to Sikra, filed on Jan. 20, 2016, which is fully incorporated by reference herein in its entirety. Adjustable cymbals can be attached to the tube using a clutch, which can aid in adjusting the cymbal height. Some exemplary clutches are described, for example, in U.S. Pat. No. 9,601,096 to Sikra, filed on Oct. 3, 2014, which is fully incorporated by reference herein in its entirety. Either cymbal can be adjusted so as to be, for example, separated from the other cymbal, to be in loose contact with the other cymbal, or to be in tight contact with the other cymbal.

Pedal assemblies are used as a mechanism with which a drummer can actuate a drum and/or a cymbal, such as a hi-hat, with his or her feet, thus allowing the drummer's hands to be free for use with other instruments. An example pedal assembly for use with or as part of a hi-hat is disclosed, for example, in U.S. Pat. No. 5,266,733 to Jacobson, filed on Apr. 23, 1992, which is fully incorporated by reference herein.

Variations in drummer technique mean that it is very difficult to design a single pedal assembly to meet the needs of every drummer. Such variables can include desired drumming speed, foot force, and/or desired strike point, among other variables. Adjustable pedals can provide the customization necessary to achieve some or all of a drummer's desired pedal characteristics. Example pedals with adjustable features are described in U.S. Pat. No. 9,640,154 to Sikra, filed on Jan. 20, 2016, and U.S. Pat. No. 10,832,642 to Sikra, filed on Jan. 18, 2017, each of which is fully incorporated by reference herein in its entirety. However, many adjustment mechanisms provided in the prior art for the adjustment of the height of a hi-hat pedal also change the resistance of the pedal and spring when the pedal height is changed. As a result, in many prior art systems, users cannot adjust pedal height and pedal/spring resistance independently from one another.

Hi-hat assemblies can be tall, making storage and transportation unwieldy. Some hi-hat assemblies are designed to allow a user to disengage one or more hi-hat rods from the drive mechanism, thereby permitting the instrument to be disassembled and/or collapse. However, solutions in the prior art for disengagement of the rod from the drive mechanism utilize connection mechanisms that require substantial time and effort to disengage, such as a threaded connection.

Some prior art hi-hat assemblies include an ability to fold the pedal assembly to reduce the overall size of the assembly. However, prior art hi-hat assemblies that permit folding of the pedal change the spring compression when the pedal is folded, thereby negatively affecting and/or straining the spring connected thereto.

Accordingly, there is a present need for a novel and efficient design for pedal and/or hi-hat assemblies that specifically addresses one or more of the aforementioned problems.

### SUMMARY OF THE DISCLOSURE

One embodiment of an adjustable pedal assembly for use in percussive instruments according to the present disclosure can include a base plate, and a pedal on the base plate. An axle can be connected to one or more frame posts, with the pedal and axle connected to one another. A cam assembly can be releasably coupled to the axle, and a drive link member can be connected to the cam assembly and to a spring assembly. The height of the pedal is adjustable such that the length of the spring assembly is changed less than the height of the pedal; and in some embodiments, the height of the pedal is adjustable substantially independent of spring assembly length.

One embodiment of a percussion pedal assembly system according to the present disclosure can include a spring system including a hi-hat spring and a negative spring below the hi-hat spring. In some embodiments, the negative spring can be configured as a pedal stop and/or be compressible so as to return the pedal toward its equilibrium position after the pedal rebounds from an actuation. In some further embodiments, the total length and/or load on the spring system can be adjustable independent of pedal height.

One embodiment of a hi-hat assembly according to the present disclosure can include an upper hi-hat rod, a lower hi-hat rod, and a release mechanism for connecting the two. The release mechanism can include a detent and a detent spring.

This has outlined, rather broadly, the features and technical advantages of the present disclosure so that the detailed description that follows may be better understood. Additional features and advantages of the disclosure will be described below. It should be appreciated by those skilled in the art that this disclosure may be readily utilized as a basis for modifying or designing other structures for carrying out the same purposes of the present disclosure. It should also be realized by those skilled in the art that such equivalent constructions do not depart from the teachings of the disclosure as set forth in the appended claims. The novel features, which are believed to be characteristic of the disclosure, both as to its organization and method of operation, together with further features and advantages, will be better understood from the following description when considered in connection with the accompanying figures. It is to be expressly understood, however, that each of the figures is provided for the purpose of illustration and description only and is not intended as a definition of the limits of the present disclosure.

### BRIEF DESCRIPTION OF THE DRAWINGS

The features and advantages of the various exemplary embodiments will become apparent from the following detailed description when considered in conjunction with the accompanying drawings. Where possible, the same reference numerals and characters are used to denote like features, elements, components or portions of the inventive embodiments. It is intended that changes and modifications can be made to the described exemplary embodiments without departing from the true scope and spirit of the inventive embodiments described herein as defined by the claims.

FIGS. 1A-1B show a hi-hat assembly according to one embodiment of the present disclosure.

FIGS. 2A-2B show a quick release connector receiver according to one embodiment of the present disclosure.

FIGS. 3A-3B show a quick release connector according to one embodiment of the present disclosure.

FIGS. 4A-4H show a pedal assembly according to one embodiment of the present disclosure.

FIGS. 5A-5E show a foldable pedal assembly according to one embodiment of the present disclosure.

FIGS. 6A-6D show a pedal assembly with a dual spring system according to one embodiment according to the present disclosure.

FIGS. 7A-7B show exploded views of a hi-hat assembly according to the present disclosure.

### DETAILED DESCRIPTION OF THE INVENTION

The present disclosure relates to percussion pedal systems, including without limitation pedal and/or hi-hat assemblies, and components thereof. The assemblies described herein can provide for adjustment of pedal resistance and height independent of one another or less dependent upon one another. In some embodiments according to the present disclosure, the aforementioned adjustment of resting pedal height (referring herein to the height of the pedal when at rest/equilibrium, or a resting pedal height) and resistance can be accomplished via a plurality of cams and link mechanisms such as chains, in addition to a two-spring spring assembly including, for example, a conventional hi-hat spring and a negative spring (e.g., a compression spring and a pedal stop spring). Some assemblies according to the present disclosure include a foldable base plate assembly and/or a release mechanism that enable(s) relatively quick breakdown (often referred to herein as a “quick release mechanism”) for convenient storage and transportation of the hi-hat assembly.

Throughout this description, the preferred embodiment and examples illustrated should be considered as exemplars, rather than as limitations on the present invention. As used herein, the term “invention,” “device,” “method,” “disclosure,” “present invention,” “present device,” “present method,” or “present disclosure” refers to any one of the embodiments of the invention described herein, and any equivalents. Furthermore, reference to various feature(s) of the “invention,” “device,” “method,” “disclosure,” “present invention,” “present device,” “present method,” or “present disclosure” throughout this document does not mean that all claimed embodiments or methods must include the referenced feature(s).

It is also understood that when an element or feature is referred to as being “on” or “adjacent” to another element or feature, it can be directly on or adjacent the other element or feature or intervening elements or features may also be present. It is also understood that when an element is referred to as being “attached,” “connected” or “coupled” to another element, it can be directly attached, connected or coupled to the other element or intervening elements may be present. In contrast, when an element is referred to as being “directly attached,” “directly connected” or “directly coupled” to another element, there are no intervening elements present.

Relative terms such as “outer,” “above,” “lower,” “below,” “horizontal,” “vertical” and similar terms, may be used herein to describe a relationship of one feature to another. It is understood that these terms are intended to encompass different orientations in addition to the orientation depicted in the figures.

Although the terms first, second, etc. may be used herein to describe various elements or components, these elements or components should not be limited by these terms. These terms are only used to distinguish one element or component from another element or component. Thus, a first element or component discussed below could be termed a second element or component without departing from the teachings of the present invention. As used herein, the terms “and/or,” “and,” and “or” include any and all combinations of one or more of the associated list items unless the context clearly requires otherwise.

The terminology used herein is for describing particular embodiments only and is not intended to be limiting of the invention. As used herein, the singular forms “a,” “an,” and “the” are intended to include the plural forms as well, unless the context clearly indicates otherwise. It will be further understood that the terms “comprises,” “comprising,” “includes,” “including,” “has,” “having,” and similar terms, when used herein, specify the presence of stated features, integers, steps, operations, elements, and/or components, but do not preclude the presence or addition of one or more other features, integers, steps, operations, elements, components, and/or groups thereof.

Embodiments of the invention are described herein with reference to different views and illustrations that are schematic illustrations of idealized embodiments of the invention. As such, variations from the shapes of the illustrations as a result, for example, of manufacturing techniques and/or tolerances are expected. Embodiments of the invention should not be construed as limited to the particular shapes of the regions illustrated herein but are to include deviations in shapes that result, for example, from manufacturing. Like elements among embodiments are referenced herein with the same reference numerals, except where differences are articulated.

It is understood that while the present application is written using the terms “drums,” “hi-hats,” and “cymbals” and with musical instruments generally in mind, the devices, methods, and concepts herein could be applied to fields other than musical instruments, as would be understood by one of skill in the art, including but not limited to tools, including power tools. Moreover, when feature(s) or element(s) are described with regard to one embodiment (e.g., a hi-hat), it should be understood that those feature(s) or element(s) could be used in other embodiments (e.g., a bass drum pedal, a tool, etc.).

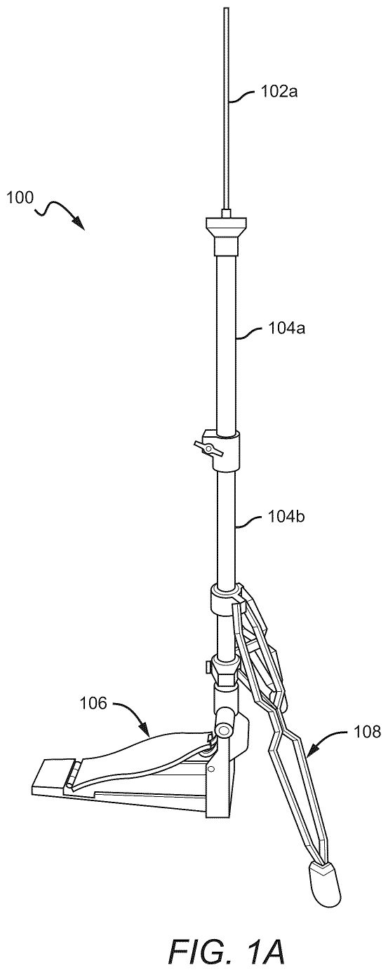

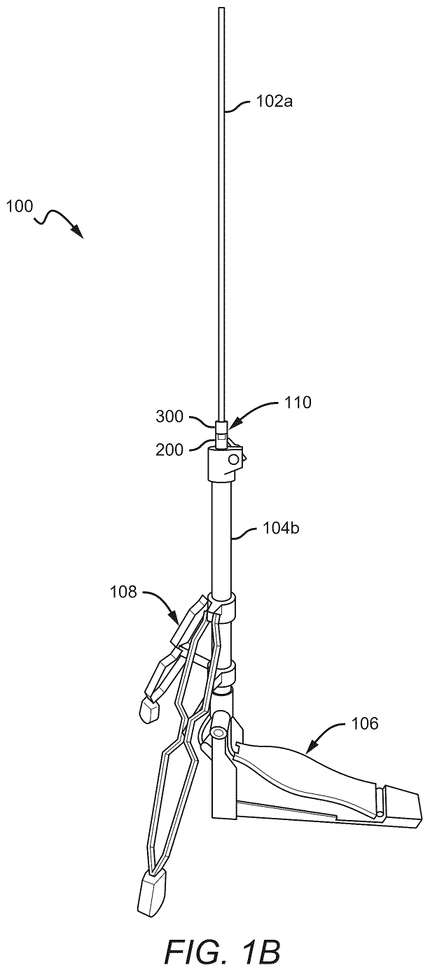

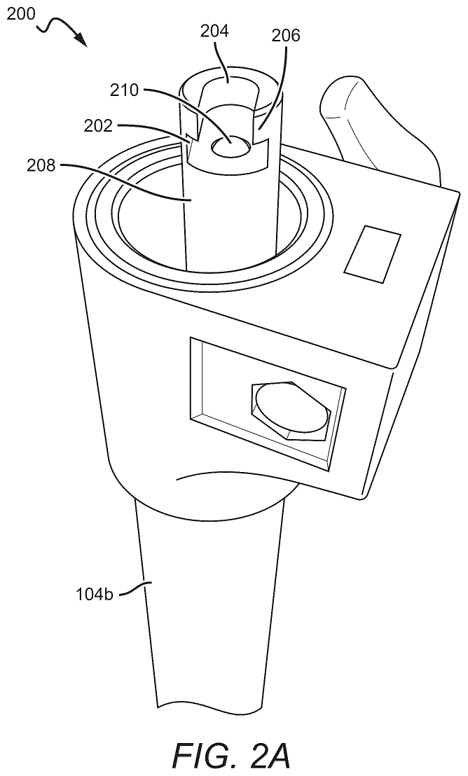

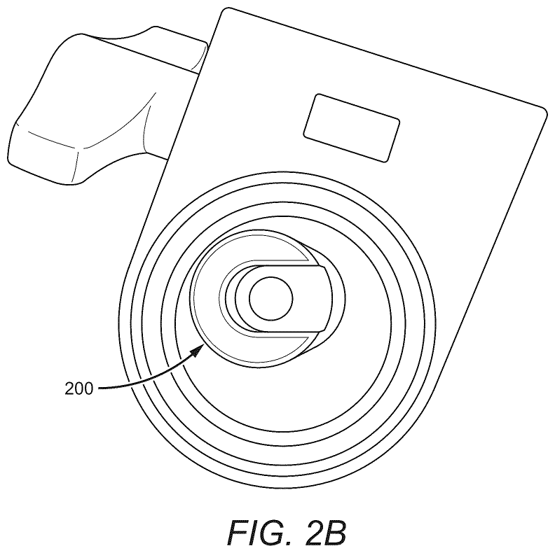

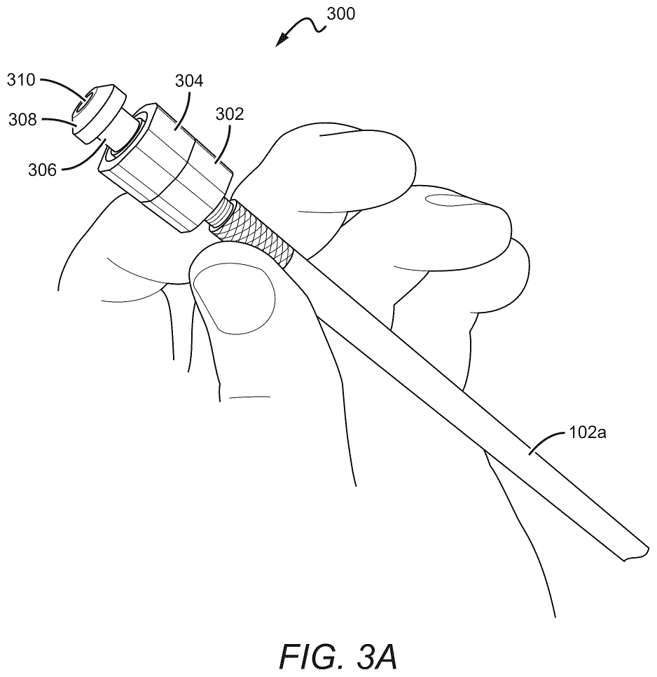

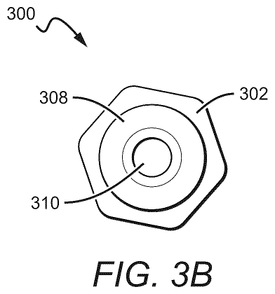

FIGS. 1A and 1B show a first embodiment of a hi-hat assembly 100 according to the present disclosure. The hi-hat assembly 100 may include an upper hi-hat rod 102a, a lower hi-hat rod 102b (not pictured in FIGS. 1A and 1B), an upper tube 104a, a lower tube 104b (the lower hi-hat rod 102b being at least partially therein), a pedal assembly 106, and a stand 108. In some embodiments according to the present disclosure, the upper hi-hat rod 102a is releasably connected to the lower hi-hat rod 102b by a quick release mechanism 110 (as shown in FIG. 1B and discussed in detail below), which may comprise a quick release connector receiver 200 and a quick release connector 300 (each described in detail herein below with regard to FIGS. 2A-2B and 3A-3B, respectively).

While not pictured, a bottom cymbal may be connected to the upper tube 104a, while the upper hi-hat rod 102a may be connected to a top hi-hat cymbal. A user's manipulation of the pedal assembly 106 controls the degree to which the aforementioned top and bottom hi-hat cymbals engage each other (often by the upper hi-hat rod 102a and top cymbal moving downward toward the bottom cymbal), enabling a plurality of sounds from the instrument.

### Quick Release Hi-Hat Rods

In some embodiments according to the present disclosure, the quick release mechanism 110 comprises a quick release connector receiver 200 connected to (or part of, e.g., integral or monolithic with) the lower hi-hat rod 102b (not shown), as shown in FIGS. 2A and 2B. The quick release connector receiver 200 may comprise one or more of a slot 202, an aperture/channel 204 (referred to hereinafter solely as a “channel” for simplicity) (e.g. a u-channel), one or more lips 206, a body 208, a detent 210 (e.g. a ball such as a ball bearing, a post, a pillar, a pin, etc.), and a detent spring 212 (not shown).

Some embodiments of the quick release mechanism 110 include a quick release connector 300, as shown in FIGS. 3A and 3B. The quick release connector 300 may be connected to or part of the upper hi-hat rod 102a and comprise one or more of a nut 302, a grip 304, a shaft 306, a head 308, and a recess 310. It should be understood that the quick release connector receiver 200 may in other embodiments be on top while the quick release connector 300 is on bottom, and/or that different elements may be swapped so as to be part of the other of the quick release connector receiver 200 or quick release connector 300, as would be understood by one of skill in the art.

Quick release mechanisms 110 comprising both a quick release connector receiver 200 and a quick release connector 300 enable a user to rapidly attach or detach the upper hi-hat rod 102a from the lower hi-hat rod 102b. Specifically, the detent 210 (biased by the detent spring 212) is configured to releasably engage with the recess 310. A user can attach the upper and lower hi-hat rods 102a,102b by gripping the grip 304, or another part of the upper hi-hat rod 102a, and sliding the shaft 306 and head 308 into the channel 204 and slot 202, respectively. The head 308 can displace the detent 210 downward as the quick release connector 300 is slotted into the quick release connector receiver 200. Once the recess 310 and the detent 210 are approximately coaxial, the detent 210 is forced into the recess 310 via the detent spring 212 (e.g., by applying upward pressure). Additionally, the detent spring 212 works to push the quick release connector receiver 200 and the quick release connector 300 apart, but the head 308 engages the lips 206 such that the quick release connector receiver 200 and the quick release connector 300 are frictionally engaged.

To separate the quick release connector receiver 200 and the quick release connector 300, the user can simply reverse the steps above, e.g., including pulling/sliding the upper hi-hat rod 102a and/or the quick release connector 200 substantially sideways out of the channel 204. Given that the upper and lower hi-hat rods 102a,102b are connected to the quick release connector 300 and the quick release connector receiver 200, connection and disconnection of the quick release connector 300 and the quick release connector receiver 200 results in connection and disconnection of the upper and lower hi-hat rods 102a,102b. Because the aforementioned connection and disconnection is accomplished through a simple sliding motion, a user can set up and take down his or her hi-hat assembly rapidly to transition between storage/transportation and play configurations, and/or to swap out upper hi-hat rods. In some embodiments, the connection and disconnection of the upper and lower hi-hat rods 102a,102b can be performed with one hand.

The quick release connector receiver 200 and the quick release connector 300 discussed hereinabove are exemplary in nature and not intended to limit this disclosure. It is understood that many different configurations of a quick release connector receiver 200 and a quick release connector 300 are possible such that upper and lower hi-hat rods 102a,102b can be quickly and releasably attached. By way of example, the detent 210, detent spring 212, and recess 310 could be replaced by, for example, a pin system. Many configurations are possible.

Some embodiments of a quick release connector 300 according to the present disclosure include an attachment mechanism (not shown) on the end opposite the recess 310 to enable the attachment of different lengths of upper hi-hat rods 102a. By way of example, the attachment mechanism may be a threaded hole formed in the quick release connector 300 and a corresponding male thread formed on one end of an upper hi-hat rod 102a. In such embodiments, the nut 302 may be used to tightly fasten the quick release connector to the upper hi-hat rod 102a. Some specific embodiments include knurling or other rough texturing on the upper hi-hat rod 102a to further aid in connection with the quick release connector 300. This is but one example of many attachment mechanisms possible, as one of skill in the art would understand.

### Adjustable Pedal Assembly

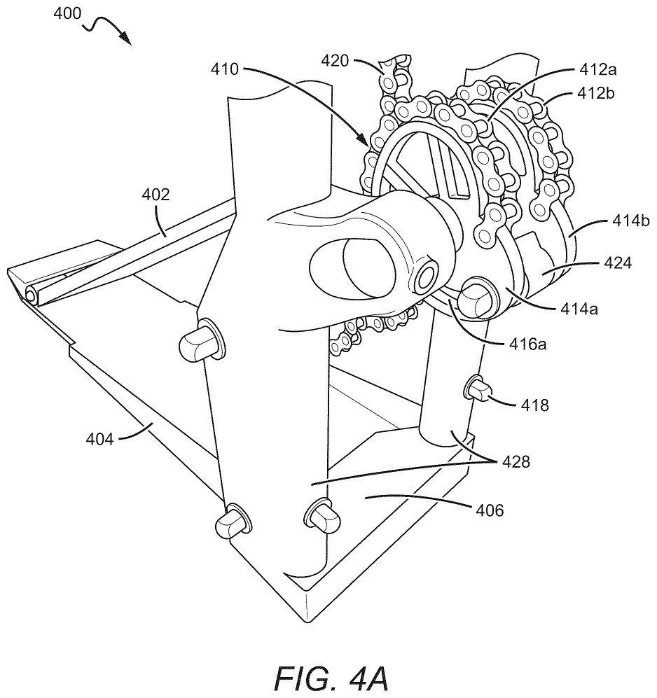

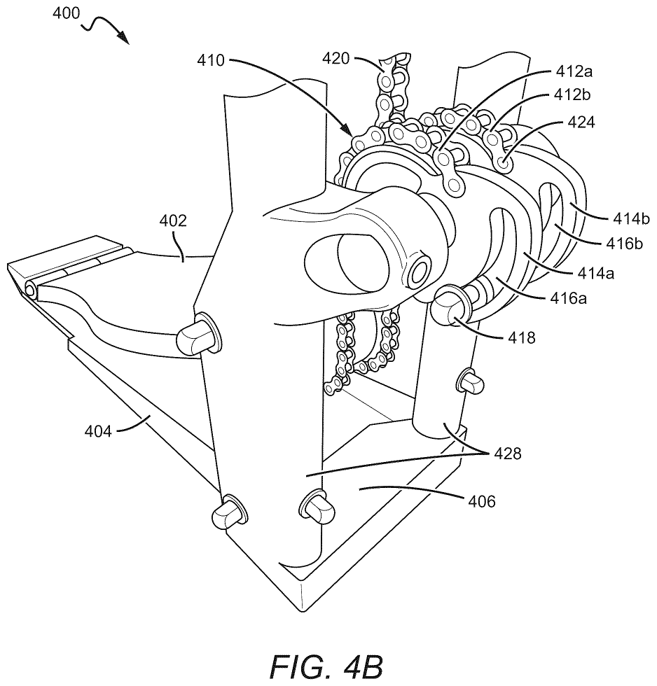

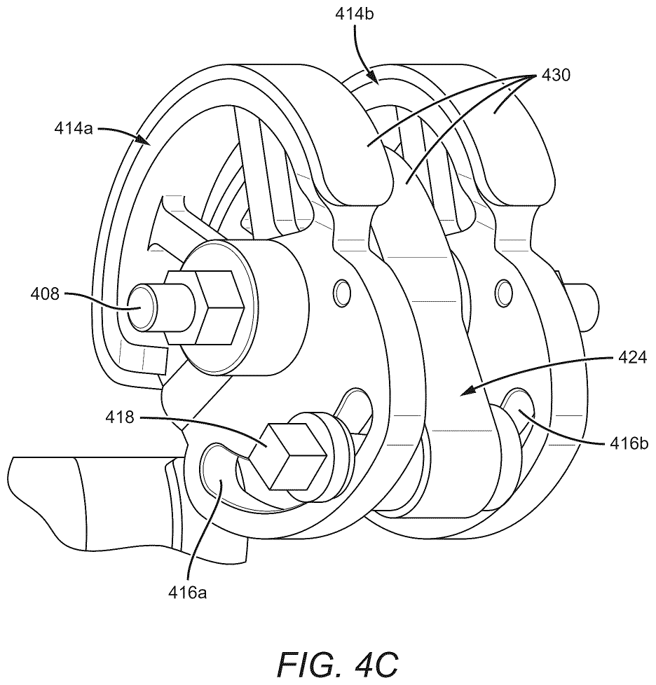

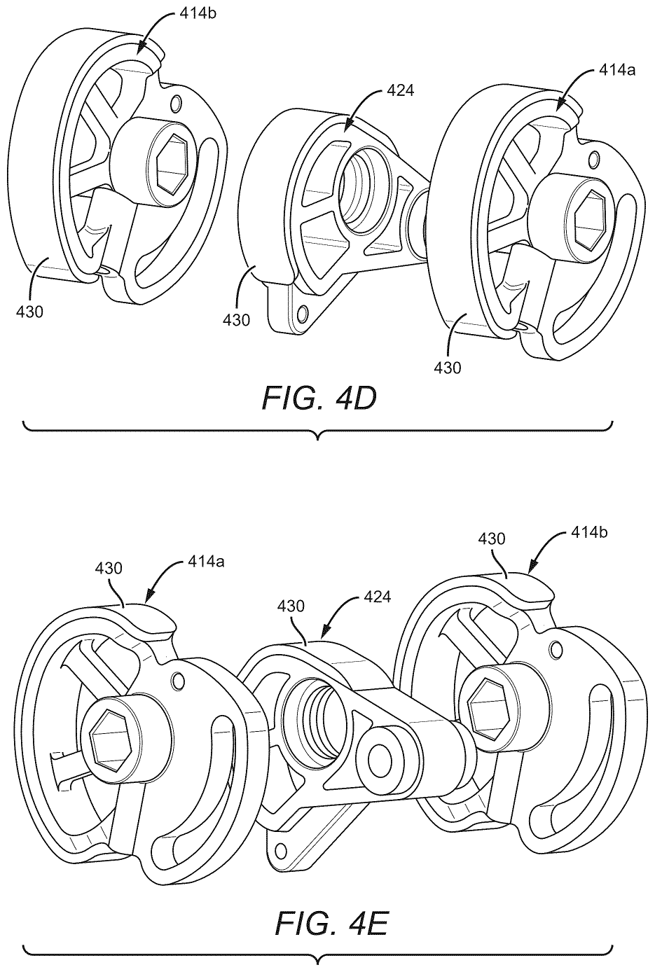

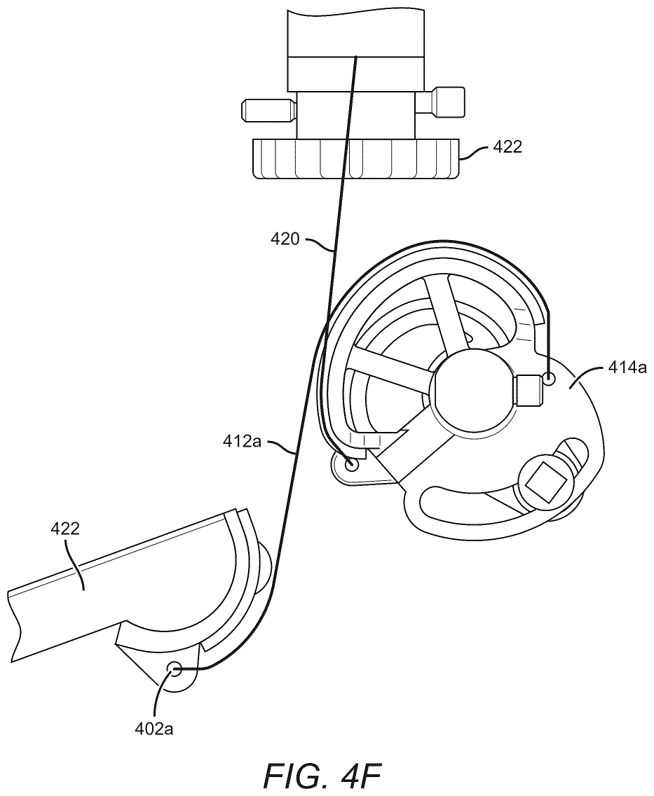

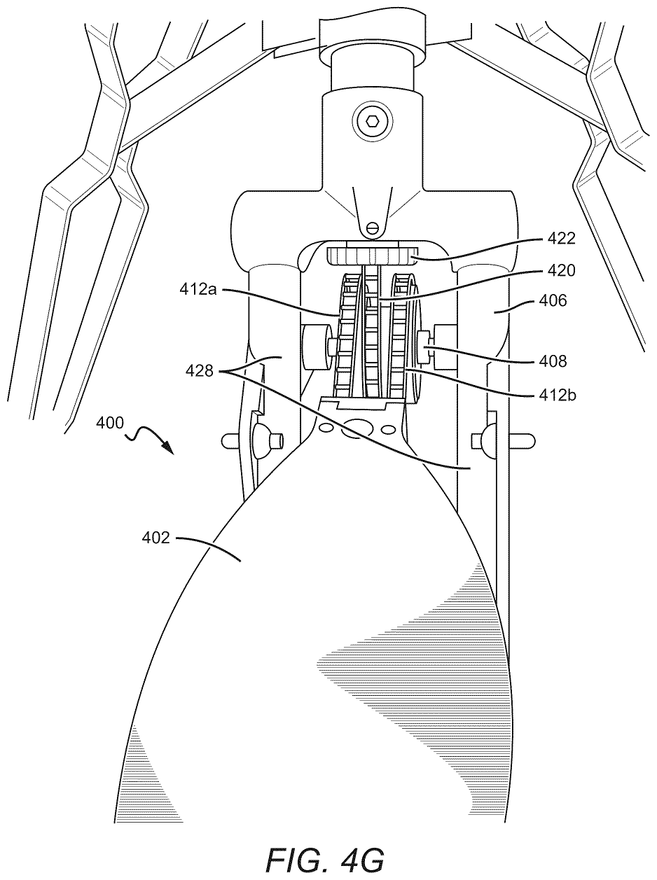

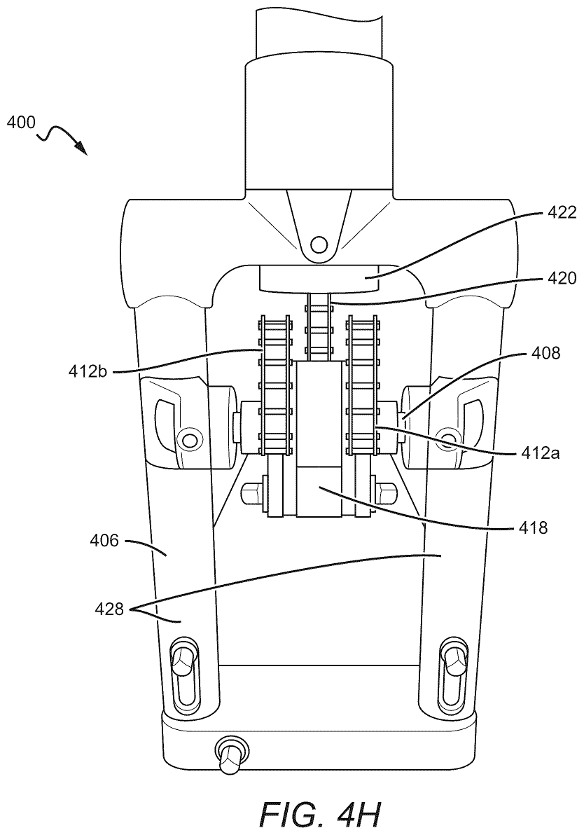

FIGS. 4A-4H show various views of a cam-adjusted pedal assembly 400 according to the present disclosure which can be used with hi-hats, such as, for example, the hi-hats 100,700 described herein. In some embodiments according to the present disclosure, the cam-adjusted pedal assembly 400 can include a pedal 402, a base plate 404, a base frame 406, an axle 408, a cam assembly 410 (which may include one or more of cam link members 412a,412b connected to cams 414a,414b each having one or more cam adjustment slots 416a,416b (which may be curved, such as being segments of a circle), and a pedal adjustment component 418), a drive link member 420, a drive cam 424, and frame posts 428. It is understood that different combinations of these and other components, including combinations omitting some of the above components, are possible. It is also understood that embodiments with only a single cam link member and/or cam adjustment slot are possible.

The pedal 402 may be connected to one or more cam link members 412a,412b (via, for example, a pedal connector 402a as shown in FIG. 4F), which in turn may be connected to one or more cams 414a,414b. The cam link members 412a,412b can be link members as known in the art, such as chains (as used in chain-drive pedals), rigid link members (as used in direct-drive pedals), ropes, belts, or other link members as known in the art. The cams 414a,414b may connect to the axle 408, which may releasably couple with the drive cam 424. In some embodiments, the axle 408 may be mounted in one or more bearing assemblies (not shown) housed in the frame posts 428, though it is understood that other arrangements for the bearing assemblies are possible, such as being mounted on the base plate 404 and/or the base frame 406. The drive link member 420 may connect with the drive cam 424. In some embodiments, the drive link member 420 may connect to a lower hi-hat rod 102b, or to another mechanism known in the art such as one or more bass drum beaters. While two cam link members 412a,412b and two cams 414a,414b are shown in FIGS. 4A-4H, other numbers of cam link members 412a,412b and cams 414a,414b are possible, such as for example, one or more, three or more, or four or more. Similarly, while the number of cam link members 412a,412b and cams 414a,414b shown in FIGS. 4A-4H match, i.e., two of each, it is possible that the number of components mismatch, such as for example, two cam link members 412a,412b with only one cam 414a. In some embodiments, the cam link members 412a,412b and/or the cams 414a,414b are substantially symmetrical with one another about a longitudinal axis of the assembly and/or about the drive link member 420, thus preventing uneven application of a user's foot pressure. Many other combinations are contemplated.

Upon a user pressing his or her foot down on the pedal 402 towards the base plate 404, eventually reaching a bottom position if enough pressure is applied for long enough, the cam link members 412a,412b cause the cams 414a,414b to rotate about the axle 408, thereby displacing the drive link member 420 and the spring mechanism downward. The spring mechanism imparts a restoring force on the pedal 402 through the cam assembly 410, ultimately causing the pedal 402 to return to its starting position when the user removes his or her foot. A pedal stop (not shown) may be used to stop or slow the upward movement of the pedal 402 upon removal of downward force by a user's foot. Some embodiments according to the present disclosure may use a spring in addition to, in place of, and/or as a pedal stop (discussed further below), and other embodiments may use a solid stop, e.g., a bump stop, to halt upward movement of the pedal 402. Stops in embodiments of the present disclosure may include, for example, foam, rubber, and/or felt stoppers, though other materials are also possible. It is noted that a plethora of positions between the starting position and the bottom position are possible. This variety of positions enables the user to alter the degree to which (if at all) the top and bottom cymbals contact each other when the hi-hat is played.

In some embodiments according to the present disclosure, the resting height, or incline angle, of the pedal 402 can be adjusted relative to the base plate 404. In specific embodiments, the height of the pedal 402 can be adjusted by loosening the pedal adjustment component 418. When tightened, the pedal adjustment component 418 (e.g., a connector, such as a drum screw) couples the drive cam 424 to the cams 414a,414b and/or axle 408 by frictionally engaging the cam adjustment slots 416a,416b, the cams 414a,414b being connected to the axle 408. Conversely, when loosened, the drive cam 424 is decoupled from the axle 408 such that the cams 414a,414b and the axle 408 can be rotated freely relative to the drive cam 424. As the cams 414a,414b are rotated, the pedal 402 is pulled upward or released downward via the cam link members 412a,412b. When the user achieves a desired height of the pedal 402, the pedal adjustment component 418 may be tightened, thereby recoupling the drive cam 424 to the axle 408. Critically, because the drive link member 420 is decoupled from the axle 408 during pedal 402 height adjustment, the pedal 402 height is adjustable independent of the length of the spring system connected to the drive link member 420, and/or adjustable so as to cause less spring system adjustment than prior art devices, because the cams 414a,414b (and cam link members 412a,412b) are not engaging the spring system as the pedal height is adjusted. Consequently, the height of the pedal 402 can be adjusted independently of the resistance delivered to the pedal 402 (and/or so as to cause less compression/resistance change than prior art devices).

In some embodiments according to the present disclosure, the pedal 402 height adjustment may not be completely independent of the spring system adjustment. For instance, in some embodiments, a change in the pedal 402 height may result in a change in length of the spring system that is less than the pedal 402 height change. In more specific embodiments, the length of the spring system may be changed by 10% of the change in height of the pedal 402. It is understood that many different percentages are possible, such as for example changes in pedal 402 height resulting in corresponding spring system length changes of 5% or less, 15% or less, 25% or less, 50% or less, 75% or less, 90% or less, or 99% or less. It is noted that the foregoing percentages are merely exemplary in nature and not intended to limit the present disclosure.

Although the drive cam 424 decouples from the axle 408 in the embodiment shown in FIGS. 4A-4D, it is possible that the cams 414a,414b decouple from the axle 408 while the drive cam 424 remains fixed to the axle 408. Alternatively, it is possible that both the cams 414a,414b and the drive cam 424 may independently decouple from the axle 408. Many different embodiments and configurations are possible.

FIGS. 4A and 4B show two configurations of the pedal 402 adjusted between two distinct heights or incline angles. Specifically, 4A shows the pedal 402 in an elevated position, whereas 4B shows the pedal 402 in a lowered position. It can be observed that, in addition to the height of the pedal 402 differing between FIGS. 4A and 4B, the position of the pedal adjustment component 418 relative to the cam adjustment slots 416a,416b is varied between the figures. The pedal adjustment component 418 passes through the drive cam 424, fixing it in place. If the pedal adjustment component 418 is locked/tightened, then it and the drive cam 424 are fixed in position relative to the cams 414a,414b, while if the pedal adjustment component 418 is unlocked/loosened, the position of the cams 414a,414b is adjustable relative to the pedal adjustment component 418 and drive cam 424 via the cam adjustment slots 416a,416b. It should be understood that while the specific embodiment shown includes continuous slots 416a,416b, many different embodiments are possible, such as using holes, gears, and other indexing means, and adjustment can be continuous or discrete.

FIG. 4C is a perspective view of the cam assembly 410 removed from the base frame 406 and without the cam link members 412a,412b and the drive cam link member 420. FIGS. 4D-4E are exploded views of the cams 414a,414b and the drive cam 424. As best shown in FIGS. 4C-4E, one or more of the cams 414a,414b and the drive cam 424 may comprise one or more link engagement pads 430. In some embodiments, the one or more link engagement pads 430 comprise a high-friction material, such as for example, rubber or other materials known in the art, for engaging with the cam link members 412a,412b and the drive link member 420, respectively. Alternatively, the one or more link engagement pads may comprise a sprocket or other components known in the art for engaging the cam link members 412a,412b or the drive link member 420.

While the pedal adjustment component 418 shown in FIGS. 4A-4H is a square-headed bolt or drum screw, one of skill in the art would understand that many other connectors/fasteners may be used to couple the cams 414a,414b to the axle 408. For instance, a bolt and wingnut or a hex head bolt and nut may be used in lieu of a square-headed bolt. These are merely exemplary, and many other fastening mechanisms are contemplated. Similarly, while the cam-adjusted pedal assembly 400 shown in FIGS. 4A-4H is driven by chains, it is noted that other mechanisms are possible to transfer the force of a user's foot imparted on the pedal 402 to the upper and lower hi-hat rods 102a,102b. For example, a direct drive assembly or other rigid or non-rigid assemblies may be used in lieu of or in addition to one or more of the components described above. In one specific embodiment, a combination flexible/rigid link member may be used. A flexible/rigid link member, such as a chain, can be flexible in one direction, such as when rolling about a cam or similar device, but rigid in the other direction such that it does not roll or bend.

As shown in FIGS. 4D and 4E, the cams 414a,414b may comprise an axle hole 426 configured to engage with the axle 408. In some embodiments, the axle hole 426 is hexagonally shaped to match a hexagonally shaped portion of the axle 408. It is noted that other configurations and shapes (e.g., regular polygons, irregular polygons, non-polygons such as circles, etc.) are possible to ensure engagement of the cams 414a,414b with the axle 408.

FIGS. 4G and 4H show the cam-adjusted pedal assembly 400 with a spring preload adjuster 422. The spring preload adjuster 422 can be above the cam assembly 410, and the drive link member 420 can connect to and/or pass through the spring preload adjuster 422. As discussed in further detail below, in some embodiments according to the present disclosure, the resistance of the pedal 402 can be adjusted by rotating the spring preload adjuster 422. In more specific embodiments, adjustment of the spring preload adjuster 422 does not affect the height of the pedal 402 relative to the base plate 404, or affects it less than prior art devices. Many different types and embodiments of spring preload adjusters 422 are possible. In alternative embodiments, adjusters can move (e.g., linearly such as up/down and/or side to side) instead of or in addition to rotational movement.

### Foldable Pedal Assembly

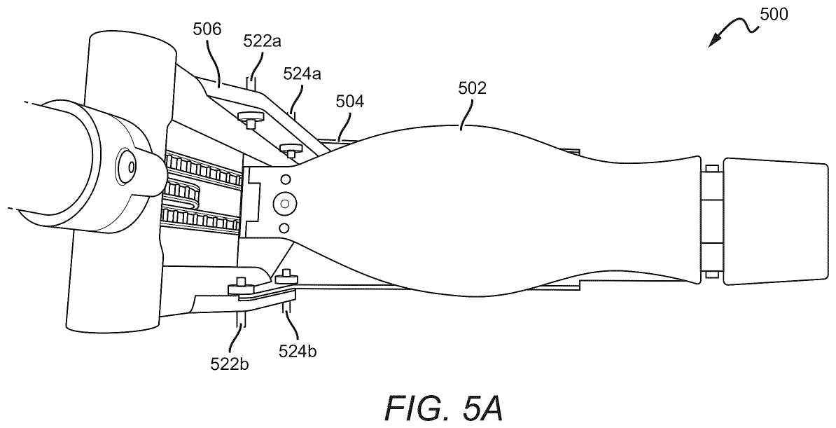

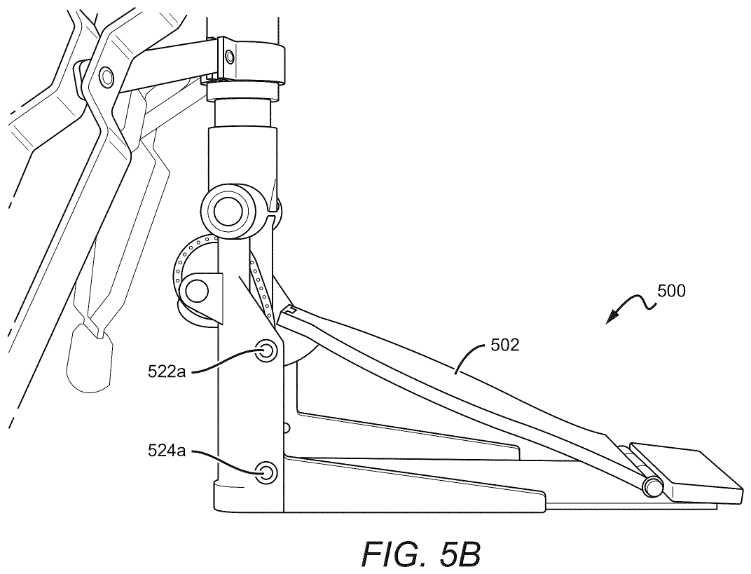

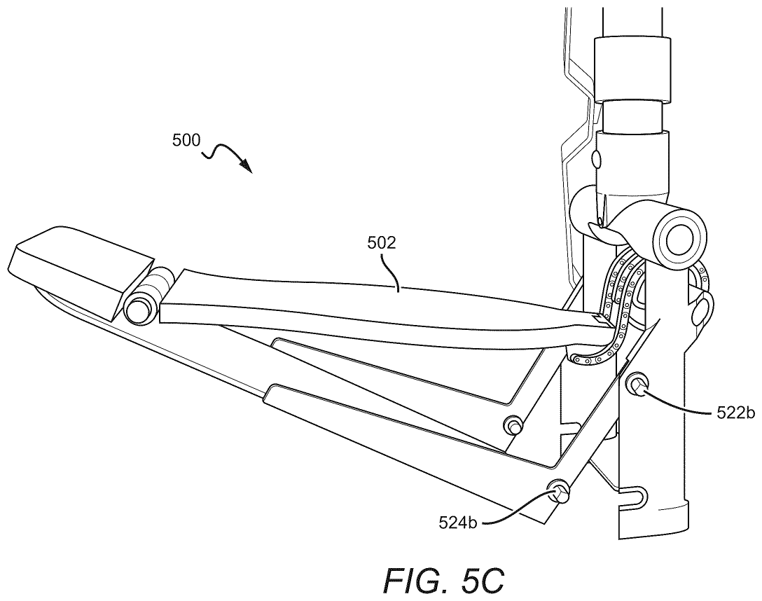

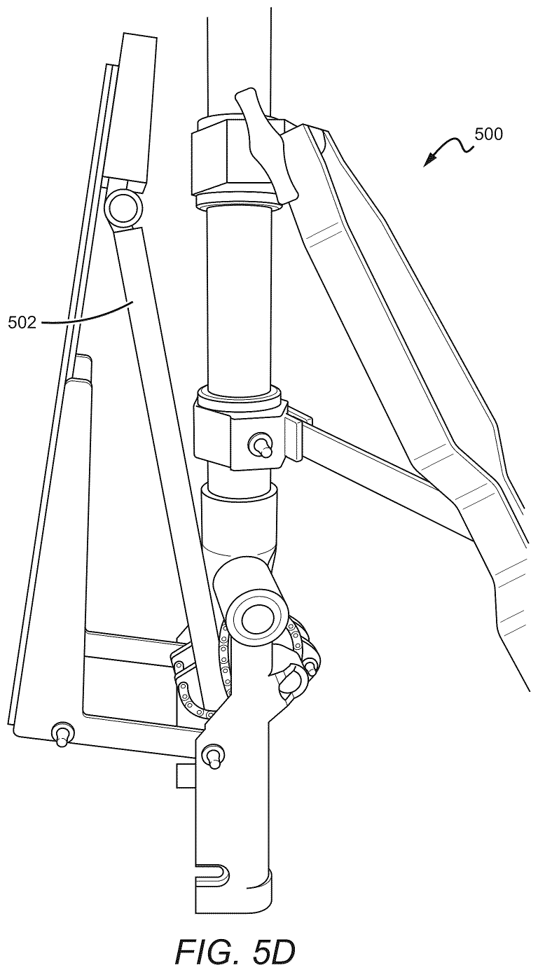

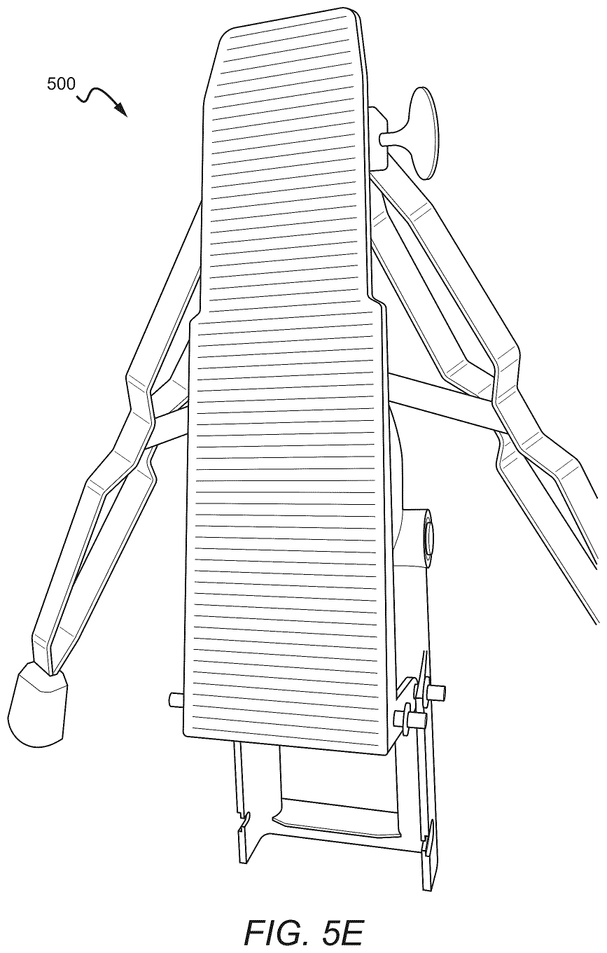

FIGS. 5A-5E show a foldable pedal assembly 500. The foldable pedal assembly 500 may comprise one or more of a pedal 502 (which may be the same as or similar to the pedal 402), a base plate 504 (which may be the same as or similar to the base plate 404), a base frame 506 (which may be the same as or similar to the base frame 406), an axle 508 (which may be the same as or similar to the axle 408), a cam assembly 510 (which may be the same as or similar to the cam assembly 410), one or more cam link members 512a,512b (which may be the same as or similar to the cam link members 412a,412b), and a drive link member 520 (which may be the same as or similar to the drive link member 420). Additionally, the foldable pedal assembly 500 may comprise one or more pivot fasteners 522a,522b and one or more base plate fasteners 524a,524b.

As best shown in FIGS. 5B-5D, the foldable pedal assembly 500 can be transitioned between a deployed state (as shown in FIG. 5B) and a folded state (as shown in FIG. 5D). FIG. 5C shows the foldable pedal assembly 500 in transition between a deployed state and a folded state. In the deployed state, the base plate fasteners 524a,524b affix the base plate 504 to the base frame 506. To begin transitioning the foldable pedal assembly 500 to a folded state, the user can loosen the base plate fasteners 524a,524b. Then, the distal end of the base plate 504 may be pivoted about the pivot fasteners 522a,522b and toward the base frame 506. Folding the foldable pedal assembly 500 results in a reduced overall size, which aids in storage and transportation of the foldable pedal assembly 500.

When the foldable pedal assembly 500 is in a deployed state, the user may adjust the height of the pedal 502 in a fashion identical to or similar to the adjustment of the pedal 402. Similarly, the user may adjust the resistance of the pedal 502 caused by a spring system in a fashion identical to or similar to the resistance adjustment of the pedal 402 and as further described below with regard to a spring assembly. In some embodiments according to the present disclosure, folding the foldable pedal assembly 500 does not change one or more of the height or resistance of the pedal 502.

Foldable pedal assemblies disclosed in the prior art increase wear and tear on springs and/or spring systems because the act of folding the pedal and/or pedal assembly results in the displacement (i.e., compression or tensioning) of a hi-hat spring. Storage of prior art folding pedal assemblies in such a configuration is likely to result in elastic fatigue of the hi-hat spring, which can eventually cause a deformed spring incapable of normal and intended operation.

It is noted that while the pivot fasteners 522a,522b and the base plate fasteners 524a,524b are referred to generally as “fasteners,” and are shown as square-headed bolts, other components may be used in lieu of fasteners. For instance, the pivot fasteners 522a,522b may be replaced by, for example, bearings or pins. Similarly, the base plate fasteners 524a,524b may be replaced by, such as for example, screws, hex-head bolts, or pins. Additionally, while two pivot fasteners 522a,522b and two base plate fasteners 524a,524 are depicted in FIGS. 5A-5E, other numbers of components and combinations of components are possible. For instance, one pivot fastener 522a may be used in combination with two base plate fasteners 524a,524b, and vice versa. Further, less than or more than two of each of the pivot fasteners 522a,522b and the base plate fasteners 524a,524 are possible.

### Spring Assembly

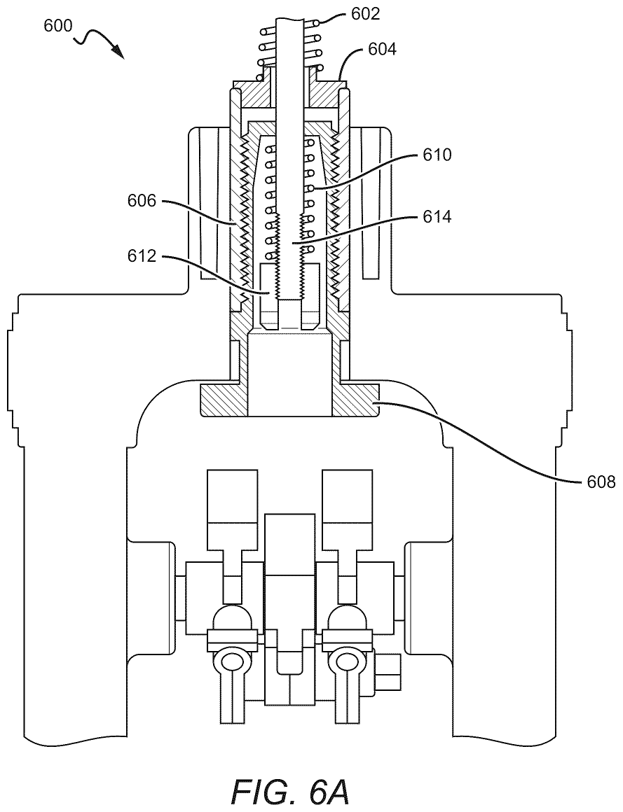

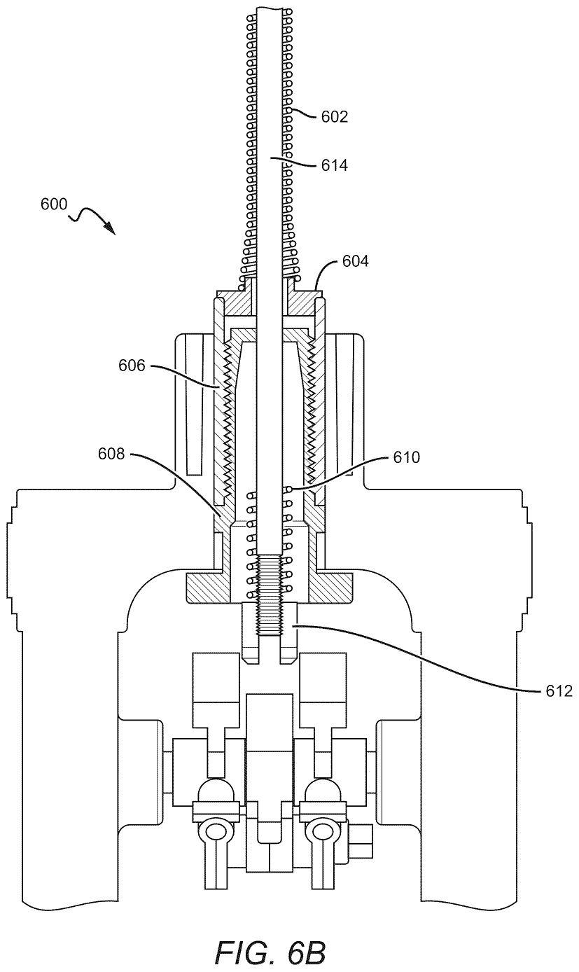

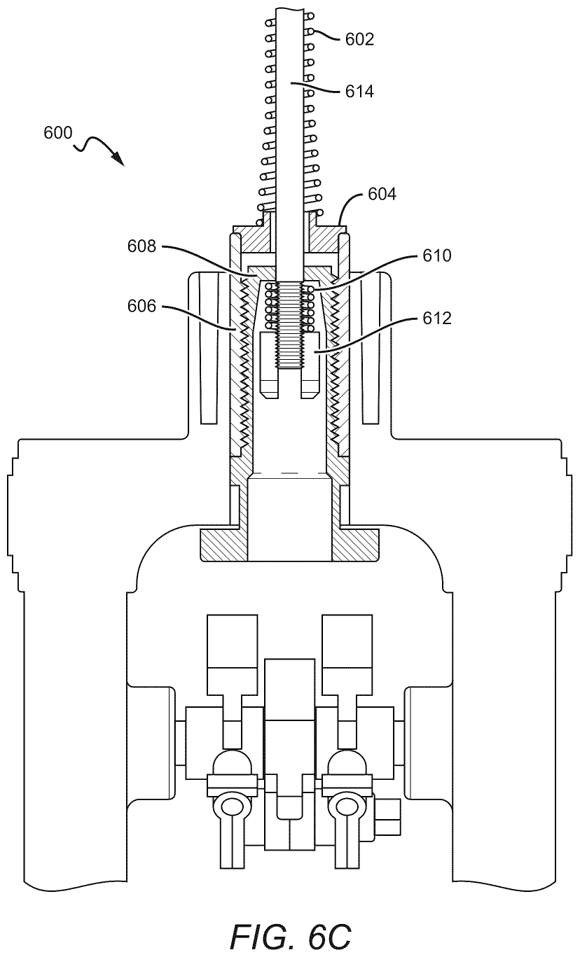

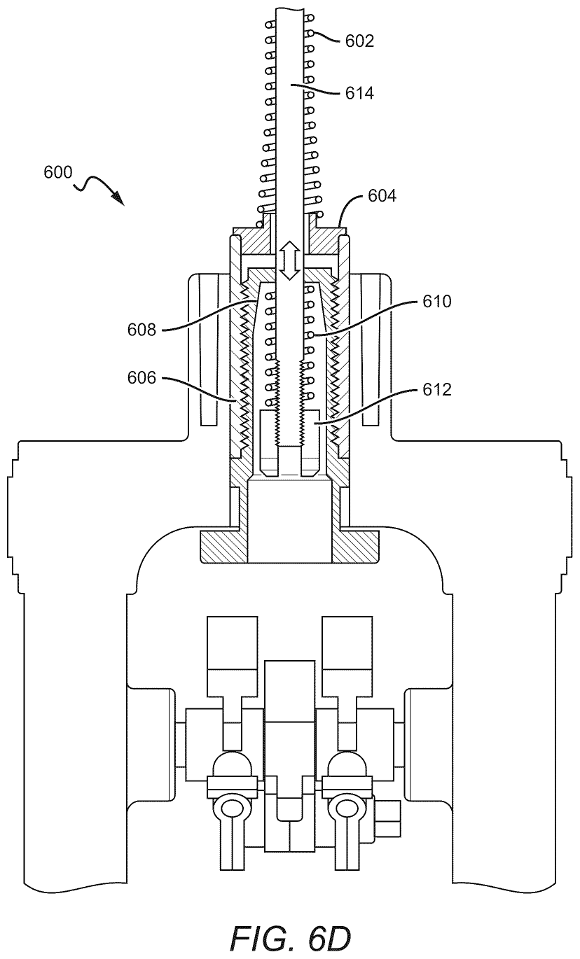

FIGS. 6A-6D show various views of a spring system 600 (e.g., a dual spring system) within a hi-hat assembly according to the present disclosure. The spring system 600 may include one or more of a hi-hat spring 602, a hi-hat spring receiver 604, a slide bushing 606, a spring preload adjuster 608, a negative spring 610, and a chain connector 612. As shown in FIGS. 6A-6D, the hi-hat spring 602 may be 2-20 inches in length, or 4-10 inches in length, or approximately 6 inches in length, while the negative spring 610 may be 0.5-5 inches in length, or 1-3 inches in length, or less than 5 inches in length, or less than 3 inches in length, or more than 0.5 inches in length, or more than 1 inch in length, or approximately 1.5 inches in length, or any combination of these dimensions. The negative spring 610 may be shorter than the hi-hat spring 602, such as 75% or less of its length, 50% or less of its length, 25% or less of its length, or other lengths. Many different lengths of the hi-hat spring 602 and the negative spring 610 within and outside these ranges are possible. In some embodiments, the negative spring 610 is substantially shorter than the hi-hat spring 604, which can help to prevent inadvertent drum/cymbal actuation upon removal of a user's foot from the pedal.

In some embodiments according to the present disclosure, the spring system 600 is at least partially (e.g., partially or wholly) contained within a lower tube, which may be the same as or similar to the lower tube 104b. In some embodiments, the hi-hat spring 602 is wholly contained within the lower tube while the negative spring 610 is partially or wholly contained within the lower tube. Many different embodiments are possible.

The spring system 600 may connect to a lower hi-hat rod 614, which may be the same as or similar to the lower hi-hat rod 102b, via one end of the chain connector 612. The other end of the chain connector 612 may connect to a drive link member 620 (not pictured) (which may be the same as or similar to the drive link members 420,520) that may in turn connect to a pedal assembly (not pictured), which may be the same as or similar to the cam-adjusted pedal assembly 400 or the foldable pedal assembly 500 (or some combination of the foregoing). The chain connector 612 and the negative spring 610 may be housed within the spring preload adjuster 608 such that they may move vertically therein. The spring preload adjuster 608 can be, at least partially, located within the slide bushing 606. In some embodiments, the spring preload adjuster 608 is configured to engage with the slide bushing 606 (as detailed below). In some embodiments, both the slide bushing 606 and the spring preload adjuster 608 may be connected to or housed within a pedal assembly. The chain connector 612 may connect the spring system 600 to drive mechanisms other than chain drives, such as for example a direct drive or other rigid or non-rigid assemblies, such as belt-driven assemblies.

FIG. 6A shows each of the hi-hat spring 602 and the negative spring 610 relaxed and in an equilibrium position, such as when the spring system 600, pedal, and/or hi-hat as a whole are at rest/in a resting position.

FIG. 6B shows the hi-hat spring 602 compressed and the negative spring 610 relaxed/in an equilibrium position, though lowered because the lower hi-hat rod 614 has been pulled downward (e.g., by downward motion of the pedal). When a user presses their foot down on the pedal, the drive link member 620 (not shown) imparts a downward force on the chain connector 612, thereby pulling the lower hi-hat rod 614 downward. A component fixed to or part of the lower hi-hat rod 614 (not pictured), e.g. a washer, abuts the top or an upper portion of the hi-hat spring 602 and compresses it as the component and top/upper portion of the hi-hat spring 602 move downward with the lower hi-hat rod 614.

FIG. 6C shows the negative spring 610 compressed with the hi-hat spring 602 relaxed/in an equilibrium position. When the user removes the downward force on the pedal, the lower hi-hat rod 614 moves upward due to the stored energy in the hi-hat spring 602. Eventually, the end of the negative spring 610 distal from the pedal may reach a maximum height, such as when it encounters a stopping element such as the slide bushing 606 or spring preload adjuster 608. The negative spring 610 then begins compressing as the chain connector 612 continues its upward movement, due to momentum, such as to the position shown in FIG. 6C. Once the momentum of the system is overcome (e.g., by the restoring force imparted by the compression of the negative spring 610), the chain connector 612 and the lower hi-hat rod 614 may begin to again move downward toward the pedal's equilibrium position. Oscillation may continue as the negative spring 610 and the hi-hat spring 602 compress and lose energy until the spring system 600 reaches equilibrium, eventually settling to the resting/equilibrium position shown in FIG. 6A.

Many prior art solutions include, for instance, a felt bump stop, which abruptly ceases the upward momentum of a foot pedal and hi-hat rod. Such solutions cause an unpleasant “clonk” sound when the foot pedal suddenly smacks into the bump stop. The negative spring 610, on the other hand, provides dampening that quietly returns the hi-hat assembly to its equilibrium state. Additionally, the use of a spring may improve the subjective “feel” of the hi-hat assembly to certain users by providing the feeling of a floating pedal bereft of an abrupt stop. It is understood, however, that a pedal stop such as those in the prior art could be utilized in embodiments of the present disclosure.

In some embodiments according to the present disclosure, a user may adjust the resistance of the spring system 600 by rotating the spring preload adjuster 610. With reference to FIG. 6D, the spring preload adjuster 608 can engage with the slide bushing 606, via for example, corresponding threads, to move the slide bushing 606 upward or downward (i.e., away from or towards the pedal assembly, respectively). Given that the hi-hat spring receiver 604 is attached to the slide bushing 606, the movement of the slide bushing 606 upward can compress the hi-hat spring 602. This in turn increases the preload (i.e., compression) on the hi-hat spring 602, thereby causing a user to experience greater resistance upon actuation of the pedal. Additionally, increasing the preload can reduce the oscillation behavior described above. As discussed hereinabove, in some embodiments, adjustment of the preload does not change the pedal height; in others, the preload adjustment results in a height change in the pedal less than the length change of the hi-hat spring 602, such as 90% or less, 75% or less, 50% or less, 25% or less, 10% or less, or 5% or less. Additionally, while the hi-hat spring 602 and the negative spring 610 are shown configured as compression springs, one of skill in the art would understand that either or both springs could instead be configured as tension springs. For instance, in a tension spring embodiment, one spring, two springs, or more could be mounted directly to and/or connected to the cam(s) and/or a direct drive link member could be used in place of a chain or flexible member.

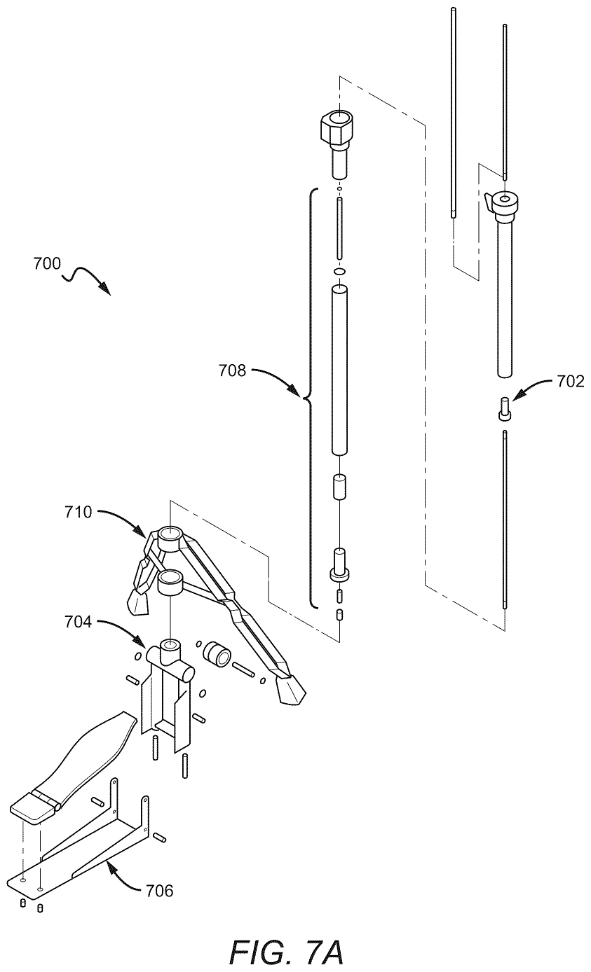

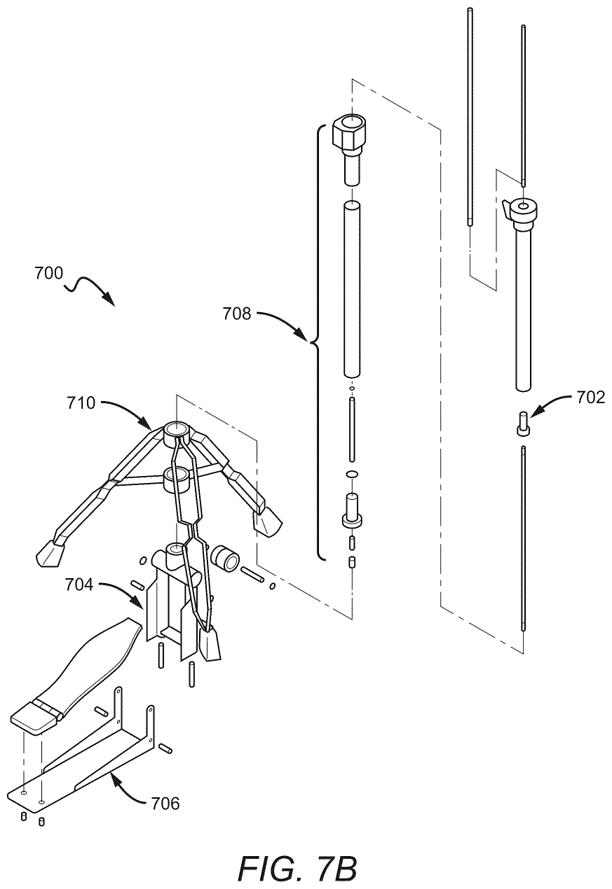

An exploded view of an exemplary hi-hat assembly 700 is shown in FIGS. 7A-7B incorporating all embodiments described in FIGS. 1A to 6D above. Specifically, the hi-hat assembly 700 includes a quick release mechanism 702, a cam-adjusted pedal assembly 704, a foldable pedal assembly 706, and a spring system 708. The hi-hat assembly 700 may comprise a stand 710 with, for example, two legs (as shown in FIG. 7A) or three legs (as shown in FIG. 7B). It is understood that more or fewer legs than two or three are possible.

The various exemplary inventive embodiments described herein are intended to be merely illustrative of the principles underlying the inventive concept. It is therefore contemplated that various modifications of the disclosed embodiments will without departing from the inventive spirit and scope be apparent to persons of ordinary skill in the art. They are not intended to limit the various exemplary inventive embodiments to any precise form described. Other variations and inventive embodiments are possible in light of the above teachings, and it is not intended that the inventive scope be limited by this specification, but rather by the claims following herein.

Although the present invention has been described in detail with reference to certain preferred configurations thereof, other versions are possible. Embodiments of the present invention can comprise any combination of compatible features shown in the various figures, and these embodiments should not be limited to those expressly illustrated and discussed. Therefore, the spirit and scope of the invention should not be limited to the versions described above. Moreover, it is contemplated that combinations of features, elements, and steps from the appended claims may be combined with one another as if the claims had been written in multiple dependent form and depended from all prior claims. Combination of the various devices, components, and steps described above and in the appended claims are within the scope of this disclosure. The foregoing is intended to cover all modifications and alternative constructions falling within the spirit and scope of the invention.

We claim:

1. A percussion pedal system comprising:
a spring system comprising:
a hi-hat spring; and
a negative spring below said hi-hat spring.

2. The percussion pedal system of claim 1, wherein said negative spring is configured as a pedal stop.

3. The percussion pedal system of claim 1, wherein said hi-hat spring is a compression spring and said negative spring is a compression spring.

4. The percussion pedal system of claim 1, wherein said negative spring is shorter than said hi-hat spring.

5. The percussion pedal system of claim 1, further comprising:
a pedal; and
a hi-hat rod connected to said pedal, said hi-hat rod through said spring system;
wherein said percussion pedal system is configured such that downward movement of said pedal causes downward movement of said hi-hat rod and compression of said hi-hat spring; and
wherein said percussion pedal system is configured such that rebounding of said pedal with sufficient force causes compression of said negative spring.

6. The percussion pedal system of claim 1, further comprising:
a hi-hat spring receiver under said hi-hat spring;
a slide bushing connected to said hi-hat spring receiver;
a preload adjuster partially within said slide bushing and comprising threads on an exterior of said preload adjuster configured to engage said threads in said slide bushing;
a chain connector within said preload adjuster and configured to attach to a lower hi-hat rod on a first end and configured to attach to a drive chain on a second end.

7. The percussion pedal system of claim 1, wherein rotation of said preload adjuster changes the position of said slide bushing.

8. The percussion pedal system of claim 1, wherein rotation of said spring preload adjuster changes the compression of said hi-hat spring.

9. The percussion pedal system of claim 1, wherein rotation of said spring preload adjuster changes the resistance of said negative spring.

10. The percussion pedal system of claim 1, further comprising:
said lower hi-hat rod and said drive chain, said chain connector connecting said drive chain to said lower hi-hat rod;
a cam assembly connected to said lower hi-hat rod; and
a pedal having a height and connected to said lower hi-hat rod,
wherein the height of said pedal is adjusted less than the change in length of said hi-hat spring when said spring preload adjuster is rotated.

11. A hi-hat with an adjustable pedal assembly, comprising:
a base plate;
a pedal on said base plate, said pedal having a pedal height;
an axle connected to one or more frame posts, said pedal connected to said axle;
a cam assembly, at least a portion of said cam assembly being releasably connected to said axle; and
a drive link member connected to said cam assembly and connected to a spring assembly having a length;
wherein upon adjustment of said pedal height, said length of said spring assembly is changed less than said pedal height.

12. The adjustable pedal assembly of claim 11, wherein said cam assembly comprises:
a first cam and a second cam, said first cam defining a first cam adjustment slot and said second cam defining a second cam adjustment slot, said first cam and said second cam connected to said axle;
a first cam link member connecting said pedal to said first cam, and a second cam link member connecting said pedal to said second cam;
a drive cam connected to said drive link member; and
a pedal adjustment component configured for frictional engagement with said first and second cam adjustment slots so as to releasably couple said drive cam to said axle.

13. The adjustable pedal assembly of claim 12, wherein said drive cam is configured to decouple from said axle upon loosening of said pedal adjustment component.

14. The adjustable pedal assembly of claim 12, wherein said first and second cams are configured to decouple from said drive cam upon loosening of said pedal adjustment component.

15. The adjustable pedal assembly of claim 12, wherein said pedal height is adjustable independent of said length of said spring assembly.

16. The adjustable pedal assembly of claim 12, wherein said first cam and said first cam link member are on a first side of said drive cam and said second cam and said second cam link member are on a second side of said drive cam.

17. The adjustable pedal assembly of claim 16, wherein said first cam and said first cam link member are symmetrical about said drive cam with said second cam and said second cam link member.

18. The adjustable pedal assembly of claim 12, configured such that adjustment of the position of said pedal adjustment component relative to said first and second cam adjustment slots adjusts said pedal height.

19. A hi-hat assembly, comprising:
an upper hi-hat rod;
a lower hi-hat rod; and
a release mechanism for connecting said upper hi-hat rod to said lower hi-hat rod, said release mechanism comprising:
a detent; and
a detent spring connected to said detent and configured to return said detent to a resting position.

20. The hi-hat assembly of claim 19, wherein said release mechanism further comprises:
a release connector receiver; and
a release connector configured to releasably connect to said release connector receiver.

21. The hi-hat assembly of claim 20, wherein said release connector receiver comprises lips configured to frictionally engage with said release connector upon connection of said release connector to said release connector receiver.

22. The hi-hat assembly of claim 21, wherein said release connector comprises a head for releasable attachment of said upper hi-hat rod, said lips configured to frictionally engage with said head.

23. The hi-hat assembly of claim 22, wherein said release connector comprises a recess configured to receive said detent upon connection of said upper hi-hat rod and said lower hi-hat rod.

24. The hi-hat assembly of claim 20, wherein said lower hi-hat rod comprises or is connected to said detent, said detent spring, and said release connector receiver, and wherein said upper hi-hat rod comprises or is connected to said release connector.
